(19) United States
(12) Patent Application Publication
(10) Pub. No.: US 2024/0400221 A1
(43) Pub. Date: Dec. 5, 2024

(54) Flexible composite structure, aircraft fuel retention device, fuel tank and aircraft incorporating same

(71) Applicant: JPR, PARIS (FR)

(72) Inventors: Romain TUFFERY, AMIENS (FR); Hervé FONTAINE, AMIENS (FR); Jérémy DA COSTA, AMIENS (FR)

(21) Appl. No.: 18/679,585

(22) Filed: May 31, 2024

(30) Foreign Application Priority Data
Jun. 1, 2023 (FR) 2305506

(51) Int. Cl. B64D 37/32; B64D 37/04

(52) U.S. Cl. CPC B64D 37/32; B64D 37/04

(57) ABSTRACT

The invention relates to a flexible composite structure configured to form, in the deployed state, a device for retaining fuel of an aircraft, this retention device incorporating said structure being configured to be mounted inside and away from a wall of a tank of an aircraft containing the fuel, this tank and this aircraft.

The structure (9) is such that, if the wall is perforated, the retention device retards or reduces the fuel leak from the tank, the structure being configured so that the outer surface (Se) is mounted in the immediate vicinity and along the contour of the wall, the structure comprising an elastomer body (9A) made of a rubber composition and a reinforcing frame (9B) embedded in the elastomer body.

According to the invention, the structure (9) further comprises a fireproof frame (9C) that is embedded in the elastomer body away from the reinforcing frame, the rubber composition being based on at least one fluorosilicone rubber.

### TECHNICAL FIELD

The invention relates to a flexible composite structure configured to form, in the deployed state, a device for retaining fuel of an aircraft, this retention device incorporating said structure which is configured to be mounted inside and away from a wall of a tank of an aircraft containing the fuel, such a tank and an aircraft incorporating same. The invention relates to a flexible-liner retention device that is suspended away from the wall of a fuel tank of an aircraft, such as an aeroplane or a space plane, notably.

### PRIOR ART

In a known manner, aircraft fuel tanks are provided with devices to protect the aircraft and the passengers thereof against fuel leaks following perforation of the tank in the event of a crash or another impact. This is because a significant quantity of fuel can then spill out of the tank into an aircraft risk zone and cause fires liable to hinder the evacuation of passengers.

To provide protection against fuel leaking out of an aircraft tank damaged by an impact following an accident, it is in particular known to suspend a flexible liner inside the wall of the tank to retain the fuel in the tank for as long as possible, thereby reducing or at least retarding the fuel leak and enabling the passengers to be evacuated from the aircraft.

U.S. Pat. No. 5,983,945 A discloses such a liner for an aircraft fuel tank that limits the quantity of fuel spilled in the event of a crash. This liner is made of Neoprene® rubber, preferably reinforced with Nylon® threads, and is suspended inside the tank from a frame or from the wall of the tank. In normal operation, the liner floats in the fuel.

A major drawback of the liner disclosed in U.S. Pat. No. 5,983,945 A is on the one hand that the Neoprene® elastomer matrix thereof does not provide it with sufficient flexibility and resistance over time to low temperatures, high temperatures, or sustainable aviation fuel (SAF) such as JET-A1, and on the other hand that the Nylon® reinforcement thereof is not adapted to provide it with sufficient resistance against the pressure of the fuel or against tearing by the sharp edges of the perforated tank.

Another drawback of the liner disclosed in U.S. Pat. No. 5,983,945 A is that it provides inadequate fire resistance, being easily inflammable.

### SUMMARY OF THE INVENTION

One objective of the invention is to provide a flexible composite structure configured to form, in the deployed state, a device for retaining fuel of an aircraft, the device being mounted inside and away from a wall of a tank of an aircraft containing the fuel, so that the device retards or reduces the fuel leak from the tank if the wall is perforated,
the composite structure having an inner surface intended to be in contact with the fuel and an outer surface, and being configured so that, once shaped and deployed, the outer surface is mounted in the immediate vicinity of and along the contour of the wall of the tank,
the composite structure comprising an elastomer body made of a rubber composition and a reinforcing frame embedded in this body, which notably overcomes the aforementioned drawbacks.

For this purpose, a flexible composite structure according to the invention further comprises a fireproof frame that is embedded (i.e. encapsulated) in the elastomer body away from the reinforcing frame, the rubber composition being based on at least one fluorosilicone rubber.

It will be seen that, if the tank is perforated, the flexible composite structure, once deployed inside the tank along and away from the contour of the wall thereof, enables the fuel to be efficiently retained at least during a first retention phase, in order to minimize the risk of an initial spillage of a large quantity of fuel that is liable to cause a fire on board the aircraft, thereby enabling the safe evacuation of the passengers during this fuel retention phase, which significantly retards or reduces the fuel leak.

It will also be seen that the elastomer body according to the invention, which encapsulates the reinforcing frame and the fireproof frame, not only enables these frames to be bound to one another, but also:
on account of the specifically fluorosilicone matrix of the elastomer body, provides lasting flexibility over a wide range of operating temperatures of the aircraft, including low temperatures (from −55 to 80° C.), thereby enhancing the fire resistance of the structure, and
on account of the reinforcing frame and the fireproof frame embedded in this fluorosilicone matrix, provides the flexible composite structure according to the invention with significantly better mechanical strength and fire resistance compared to existing liners, such as those disclosed in U.S. Pat. No. 5,983,945 A.

It will also be seen that the flexible composite structure according to the invention, once shaped and deployed inside the tank and in contact with the fuel, has been designed to have a compact (i.e. not expandable) geometry following a perforation of the wall of the tank, unlike bladder devices or self-sealing coverings, which differ from the retention device incorporating the structure according to the invention.

“Rubber composition being based on at least one fluorosilicone rubber” in the present description means a cross-linked rubber composition in which the elastomer matrix comprises one or more fluorosilicone rubbers (FVMQ) constituting more than 50% by weight, preferably more than 75% by weight, and more preferably 100% by weight. In other words, the elastomer matrix may comprise one or more fluorosilicones as the majority component by weight and at least one other rubber other than a fluorosilicone as the minority component by weight, or may preferably be made exclusively of one or more fluorosilicones. Said at least one other minority rubber other than a fluorosilicone may be a silicone rubber such as a silicone rubber (VMQ or vinyl methyl silicone) or a phenyl-vinyl-methyl silicone (phenyl methyl-, vinyl methyl- and dimethylsiloxane terpolymer, PVMQ).

As explained below in the present description, the cross-linked rubber composition forming the elastomer body according to the invention in particular comprises a cross-linking system and other additives, in addition to the elastomer matrix based on said at least one fluorosilicone.

According to another general feature of the invention, the fireproof frame is preferably positioned between the reinforcing frame and the outer surface.

It will be seen that positioning of the fireproof frame adjacent to the outer surface of the structure, such that the reinforcing frame is adjacent to the inner surface of this structure, helps to further improve the fire resistance of said structure without adversely affecting the mechanical strength thereof.

According to another preferred feature of the invention, the inner surface and the outer surface are made of the rubber composition.

In other words, not only are the reinforcing frame and the fireproof frame then embedded in the mass of the elastomer body, but the flexible composite structure according to the invention may advantageously also have no non-elastomer layer, covering or ply (for example being devoid of textile, carbon or mineral layer) on the inner surface and on the outer surface thereof.

It will be seen that a flexible composite structure according to the invention may advantageously be made of (i.e. exclusively) said elastomer body (which may be formed by a single layer of the rubber composition) and of the fireproof and reinforcing frames embedded in said body.

According to a first aspect of the invention, the reinforcing frame may comprise at least one textile reinforcement ply that is woven or knitted, preferably woven using a continuous thread and satisfying at least one of the following conditions:
a mass per unit area of at least 250 g/m², measured according to ISO 9073-1,
a tensile strength along warp and weft of at least 1100 daN/5 cm and 1200 daN/5 cm respectively, measured according to ISO 13934-1, and
a bursting strength of at least 15.105 Pa, measured according to ISO 13938-1.

Preferably, said at least one textile reinforcement ply comprises at least one thread of a (semi) aromatic polyamide, preferably chosen from polyarylamides, poly(meta-xylylene adipamide), polyphthalamides, amorphous semi-aromatic polyamides, meta-aramids, para-aramids, and combinations of at least two of these (semi) aromatic polyamides.

More preferably, said at least one textile reinforcement ply is made of at least one thread of an aromatic polyamide, for example being made of PPTA (para-aramid or poly(para-phenylene terephthalamide)).

It will be seen that said at least one textile reinforcement ply (for example as defined above by the thread or threads of an aromatic polyamide) provides the composite structure according to the invention with:
sufficient resistance against the pressure of the fuel, and
sufficient resistance against tearing in the event of contact between the structure and sharp edges of the wall of the tank following perforation of said wall.

According to a second aspect of the invention that may be combined with said first aspect, the fireproof frame may comprise at least one woven or knitted mineral fireproof ply, preferably being woven and satisfying at least one of the following conditions in the impregnated state:
a mass per unit area of at least 250 g/m², measured according to ISO 3801,
a tensile strength along warp and weft of at least 800 N/25 mm and at least 600 N/25 mm respectively, measured according to ISO 4606,
an elongation at break along warp and weft of at least 4% and 5% respectively, measured according to ISO 13934-1, and
a bursting strength of at least 750 kPa for a test piece diameter of 30.5 mm, measured according to ISO 13938-1.

Preferably, said at least one fireproof ply comprises fibres of silica and/or a ceramic (for example ceramic such as Si—Al or Al₂O₃), preferably a continuous silica thread with a mass fraction of SiO₂ greater than 95% in said at least one ply.

More preferably, said at least one fireproof ply is made of said silica fibres.

It will be seen that said at least one fireproof ply as defined helps to provide the flexible composite structure according to the invention with satisfactory fire resistance (for example tested using a Jet A1 fuel burner) and, as detailed below, satisfactory fluidtightness measured as a water leakage rate following application of a kerosene flame, and a satisfactory self-extinguishing time in vertical and horizontal burn tests.

Advantageously, according to the first and second aspects mentioned above, the reinforcing and fireproof frames may respectively be made of a single ply of (semi) aromatic polyamide thread(s) and a single ply of silica fibres.

According to a third aspect of the invention that may be combined with said first aspect and/or said second aspect, the rubber composition may comprise:
said at least one fluorosilicone rubber, for example with a mass fraction of 80% to 88%,
electrically conductive fillers comprising for example carbon nanoparticles, preferably with a mass fraction of 10% to 15%,
a flame retardance system comprising at least one flame retardant, preferably with a mass fraction of 0.5% to 2%, and
a cross-linking system for example comprising a peroxide-based cross-linking agent (for example an aromatic organic peroxide), preferably with a mass fraction of 0.5% to 5% and for example from 1.7% to 3%.

The flame retardant may for example be inorganic fillers such as quartz, metal oxides and hydroxides, vinyl-terminated polysiloxane compounds, or polysiloxane/platinum complexes.

It will be seen that this rubber composition helps to bind the frames together by providing lasting flexibility at operating temperatures of the tank of between-55 and 80° C., and that the carbon nanoparticles thereof preferably also help ensure efficient dissipation of electrostatic charges.

Advantageously and optionally in combination with some or all of the features of the invention set out above, the rubber composition may satisfy, in the cross-linked state, at least one of the following conditions:
an average breaking strength of at least 2.5 MPa, measured in uniaxial tension according to standard ISO 37:2017,
an average elongation at break of at least 300%, measured in uniaxial tension according to standard ISO 37:2017,
secant moduli at 50%, 100% and 200% deformation respectively of at least 0.8 MPa, 1.0 MPa and 1.8 MPa, measured in uniaxial tension according to standard ISO 37:2017, and
a Shore A hardness of between 50 and 60, measured according to standard ASTM D2240.

It will be seen that these mechanical properties of the rubber composition are particularly well suited to enabling the elastomer body made of this composition to provide the flexible composite structure according to the invention with satisfactory properties for assembly thereof inside the tank and operation, including in the event of perforation of the wall of the tank, as detailed below.

Advantageously and optionally in combination with some or all of the features of the invention set out above, said flexible composite structure may satisfy, in the cross-linked state, at least one of the following conditions:
a puncture resistance according to TSO-C80, paragraph 16, greater than 1650 N,
a fire resistance according to ISO 2685:1998 or FAA AC 20-135 using a Jet A1 fuel burner of at least 5 minutes,
a fluidtightness measured as a water leakage rate, following application of a kerosene flame of 92 kW/m², for at least 5 minutes,
a self-extinguishing time according to FAR 25.853 Appendix F Part 1 in the vertical burn test according to (a1)(ii) and the horizontal burn test according to (a1)(iv), that is at least 12 seconds and at least 15 seconds burning respectively,
an electrical surface resistance of less than 10 GΩ square, and
following ageing for 1000 hours at 70° C. in Jet A1 fuel, swelling after removal from the fluid, according to standard NF ISO 1817, of less than 30% by volume and less than 20% by mass.

It will be seen that these features notably demonstrate very satisfactory properties in terms of mechanical strength, fire resistance (see in particular the self-extinguishing time obtained, which demonstrates an absence of residual flame on completion of the burn tests), dissipation of electrostatic charges and resistance to swelling after ageing, which provide the retention device according to the invention incorporating the flexible composite structure with a long service life despite the operating, perforation or fire stresses specific to aircraft.

According to another aspect of the invention that may optionally be combined with some or all of the features above, a retention device according to the invention for an aircraft fuel is as defined below.

This retention device is configured to be mounted inside and away from a wall of a tank of an aircraft containing the fuel, so that the retention device immersed in the fuel retards or reduces the fuel leak from the tank if the wall is perforated, and this device comprises:
said flexible composite structure as defined above, which has been shaped, for example by calendering and molding, then deployed along the contour of an inner face of the wall, and
means for fastening the flexible composite structure to the inner face of the wall.

These fastening means, which may be removable, preferably comprise the following, from the wall of the tank towards the inside of the flexible composite structure:
fastening lugs, for example brackets, that are fastened to an inner face of the wall of the tank and that have fastening holes,
fastening eyelets that are provided in the flexible composite structure and configured to be disposed opposite and in contact with the fastening holes,
clamping profiles that are mounted on the flexible composite structure and that have clamping openings configured to be disposed opposite and in contact with the fastening eyelets, and
male clamping members, such as bolts, that successively traverse the fastening lugs, the flexible composite structure and the clamping profiles via the fastening holes, the fastening eyelets and the clamping openings, respectively.

It will be seen that different means may be used to fasten the flexible composite structure to the inner face of the wall of the tank, i.e. fastening means other than lugs, eyelets, profiles and/or clamping members, without departing from the scope of the invention.

According to a general aspect of the invention, the retention device may be such that the flexible composite structure, once shaped and deployed:
has a manhole access opening configured to be positioned opposite an access hatch in the wall of the tank, and
is capable of being reversibly folded and/or rolled up to fit through the access opening (for example a manhole) to be subsequently deployed inside the tank.

According to another aspect of the invention that may optionally be combined with some or all of the features above, a fuel tank according to the invention, which is configured to be installed in an aircraft comprising a fuselage containing a passenger cabin, comprises:
a metal or composite rigid outer wall delimiting a compartment for the fuel, and
the retention device according to the invention as defined above, which is held by said fastening means in the immediate vicinity of the wall with an average gap between the outer surface of the flexible composite structure and the inner face of the wall of between 1 mm and 10 mm, preferably between 2 mm and 8 mm.

It will be seen that this average gap between the flexible composite structure according to the invention and the inner face of the wall of the tank is thus minimized without reaching zero (such that the flexible composite structure is not pressed against the wall of the tank during normal operation of the tank, i.e. in the absence of any perforation of the wall of the tank), which means that the minimized interstitial volume between the structure and the wall can significantly reduce the quantity of fuel not retained by said structure in the event of perforation of said wall. Such a perforation subjects the structure to the pressure of the fuel, which is directed towards the outside of the tank, thereby pressing the structure against the contour of the inner face of the wall.

It will also be seen that the retention device according to the invention, unlike an internal bladder or a self-sealing liner, is suspended inside the tank at least partially immersed in the fuel, in the immediate vicinity but away from the wall of the tank when the tank is in normal operation (only said means for fastening the flexible composite structure to the wall of the tank then being mounted in contact with this wall).

According to yet another aspect of the tank according to the invention that may optionally be combined with some or all of the features above, at least one of the sides of the retention device extending across the wall of the tank may be open, the retention device being arranged across a bottom zone and lateral zones of the wall and preferably being open across a top zone of the wall, said top zone being configured to be disposed inside the fuselage of the aircraft and beneath the cabin.

It will be noted that in this preferred tank according to the invention, the retention device thus has no flexible composite structure on the top thereof oriented towards the top zone of the wall of the tank adjacent to the cabin, said top zone of the wall being less susceptible to perforation in the event of an accident.

According to yet another aspect of the invention that may optionally be combined with some or all of the features above, an aircraft according to the invention comprises a fuselage, wings and at least one fuel tank as defined above that is housed inside the fuselage, preferably at the join between the fuselage and one of the wings.

Preferably, the aircraft according to the invention is such that said at least one tank has a lateral zone (i.e. other than said top zone and said opposing bottom zone of the wall of the tank) of said wall of the tank that is delimited by the fuselage or is adjacent to the fuselage.

It will be seen that such a location of said at least one fuel tank inside the aircraft is provided purely by way of example, i.e. the tank or one of the tanks according to the invention could be located elsewhere in the aircraft.

Other features, advantages and details of the present invention will emerge on reading the following description of several exemplary embodiments of the invention, given by way of illustration and without limitation, in connection with the appended drawings, among which:

### BRIEF DESCRIPTION OF THE DRAWINGS

FIG. 1 is a schematic perspective view of an aircraft incorporating a fuel tank according to an example embodiment of the invention.

FIG. 2 is a schematic view in cross section of the tank in FIG. 1 according to an example of the invention, the tank being fitted with a retention device.

FIG. 3 is a schematic view, in cross section in the plane III-III in FIG. 2, of a flexible composite structure included in a retention device according to an example of the invention.

FIG. 4 is a partial perspective schematic view of a flexible composite structure having the architecture illustrated in FIG. 3 once shaped, according to an example embodiment of the invention.

FIG. 5 is a partial perspective schematic view of a detail of a flexible composite structure according to the invention similar to the one in FIG. 4, shaped and deployed as close as possible to the wall of an aircraft fuel tank.

FIG. 6 is a partial schematic view in cross section in the plane VI-VI in FIG. 5 of the means for fastening the flexible composite structure to the wall of the tank, according to an example embodiment of the invention.

FIG. 7 is a photograph of a zone of a flexible composite structure similar to the one in FIG. 4, according to an example embodiment of the invention also according to FIG. 3.

FIG. 8 is a photograph of another zone of the flexible composite structure according to the example in FIG. 7, showing an access opening to a hatch of the tank.

FIG. 9 is a photograph showing the perforation device used to measure the puncture resistance of the flexible composite structure in FIGS. 7 and 8 according to the standard TSO-C80, paragraph 16.

FIG. 10 is a force=f (displacement) graph obtained for the flexible composite structure according to the invention in FIGS. 7 and 8, according to the standard TSO-C80, paragraph 16.

FIG. 11 is a diagram illustrating the protocol followed to carry out a shear strength test for a flexible composite structure according to the invention, as illustrated in FIGS. 7 and 8.

FIG. 12 is a photograph showing the test device used to carry out the shear strength test according to FIG. 11, for the flexible composite structure according to the invention.

FIG. 13 is a photograph showing the device used to carry out a fire resistance test on a flexible composite structure according to an example of the invention, as illustrated in FIGS. 7 and 8, the test being carried out according to ISO 2685:1998 or FAA AC 20-135, using a Jet A1 fuel burner.

FIG. 14 is a photograph showing the method carried out by the device in FIG. 13 for this fire resistance test, by lighting the burner.

FIG. 15 is a photograph showing a flexible composite structure according to an example embodiment of the invention, like the one in FIGS. 7 and 8, after shaping and in a folded position, before insertion and deployment inside an aircraft tank.

### EXAMPLE EMBODIMENTS OF THE INVENTION

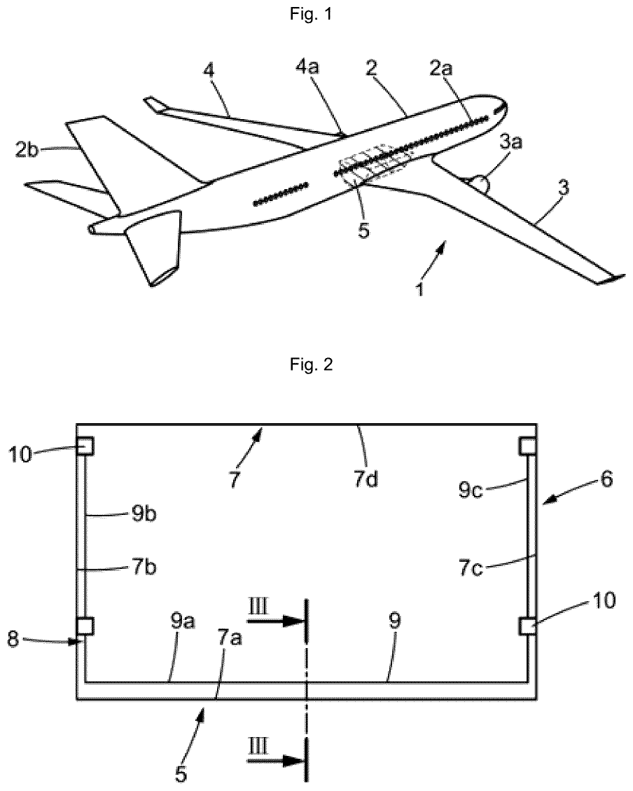

The aircraft 1 illustrated in FIG. 1 comprises a fuselage 2 delimiting a cabin 2a for passengers, wings 3 and 4 provided with jet engines 3a and 4a, a tail unit 2b, and a fuel tank 5 housed inside the fuselage 2, in this example at the join between the fuselage 2 and one of the wings 3.

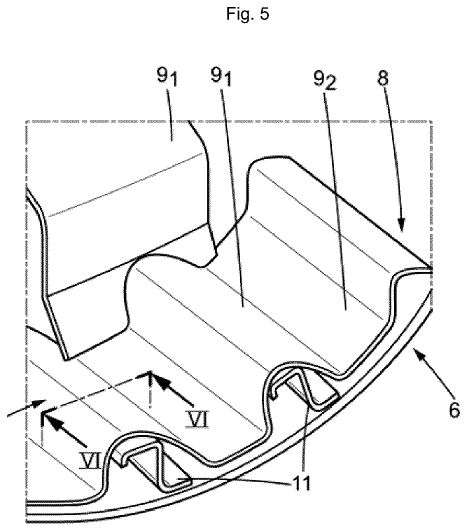

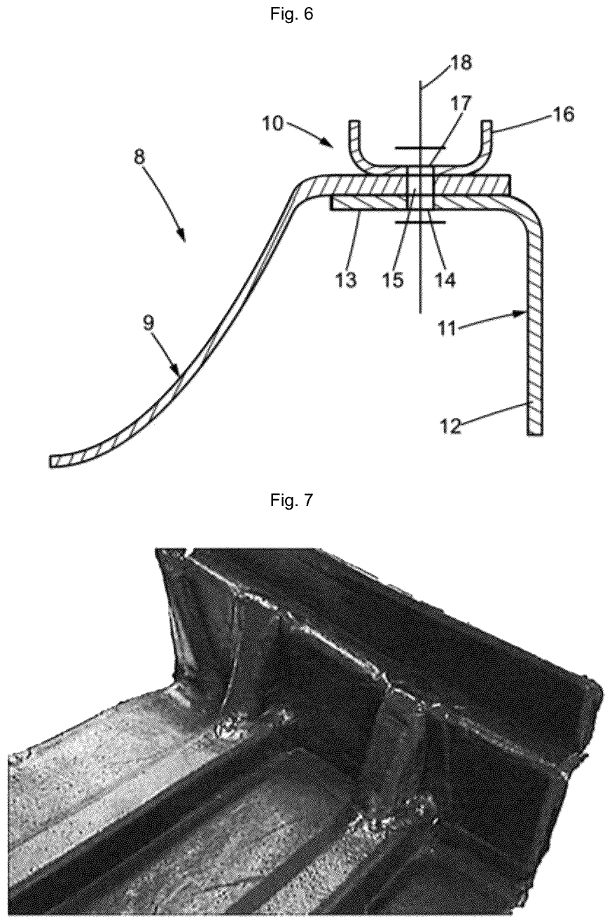

As illustrated in FIG. 2, the tank 5 comprises:
a metal or composite rigid outer wall 6 that delimits a compartment for the fuel and that has an inner face 7, and
a retention device 8 (inside the wall 6) that comprises a flexible composite structure 9 and fastening means 10 (shown symbolically in FIG. 2, these means 10 being shown in detail in FIGS. 5 and 6) for fastening the structure 9, once shaped and deployed, to the wall 6, so that in normal operation of the aircraft 1 the structure 9 is mounted in the immediate vicinity of the inner face 7 (for example with an average distance between the structure 9 and the inner face 7 of 1-10 mm, for example of 2-8 mm).

The tank 5 in FIG. 2 incorporates the structure 9 extending across and in the immediate vicinity of a bottom zone 7a of the inner face 7 and lateral zones 7b, 7c of the inner face 7 extending upwards from the bottom zone 7a. In the example in FIG. 2, the structure 9 does not extend across the top zone 7d of the inner face 7. In other words, the structure 9, once deployed inside the wall 6 of the tank 5, is open at the top, i.e. only extends across a bottom part 9a and lateral parts 9b, 9c of the structure 9, if said structure has, as in FIG. 2, an overall polyhedral three-dimensional shape, for example prismatic (i.e. having an overall polygonal cross section, for example substantially rectangular).

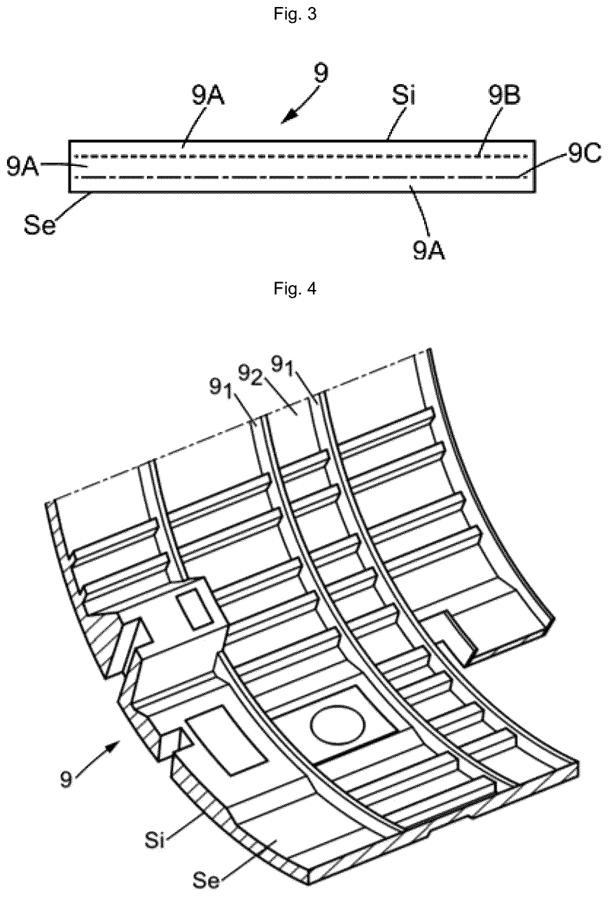

As illustrated in FIG. 3, the structure 9 is delimited by an inner surface Si (intended to be oriented towards the fuel) and an outer surface Se (intended to face the wall 6) and, according to the invention, the structure 9 comprises:
an elastomer body 9A that is made of a cross-linked rubber composition based on at least one fluorosilicone rubber (FVMQ), the inner and outer surfaces of which are respectively formed by the surfaces Si and Se, and
frames 9B and 9C that are encapsulated in the elastomer body 9A (i.e. embedded in the mass thereof, and away from the surfaces Si and Se) and that comprise a reinforcing frame 9B and a fireproof frame 9C embedded in the elastomer body 9A away from the reinforcing frame 9B.

The frames 9B and 9C may extend continuously or discontinuously over the length and/or over the width of the elastomer body 9A, each preferably extending continuously over the length thereof and the width of the body 9A (the dots and dashes visible in FIG. 3 are intended to represent two separate frames 9B and 9C, not a discontinuity over the width of the structure 9).

As also shown in FIG. 3, the fireproof frame 9C is positioned between the reinforcing frame 9B and the outer surface Se, i.e. the reinforcing frame 9B is adjacent to the inner surface Si and the fireproof frame 9C is adjacent to the outer surface Se.

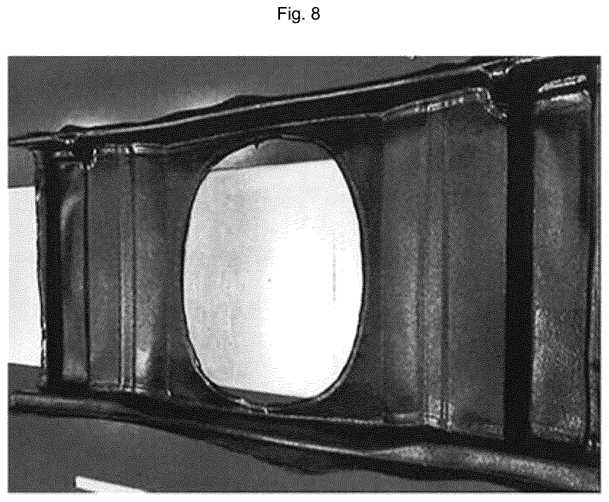

The flexible composite structure 9 illustrated in FIGS. 4 and 5 and shown in the photographs in FIGS. 7 and 8 is first shaped (i.e. formed), preferably by calendering and molding, into a complex three-dimensional shape including reliefs (for example shaped ribs 9₁) and hollows (for example shaped grooves 9₂ between two ribs 9₁) configured to adapt, once the structure 9 has been deployed and fastened to the inside of the rigid wall 6, to the three-dimensional profile or contour of the inner face 7 of the wall 6.

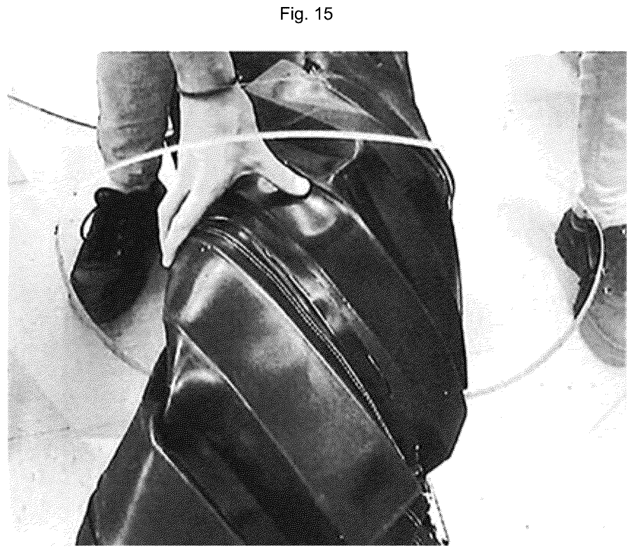

Once shaped, an operator folds the structure 9, taking advantage of the flexibility thereof as shown in the photograph in FIG. 15, to reversibly insert the structure 9 in the folded state through an access hatch to a manhole formed in the wall 6, before fastening the structure 9 to the inner face 7 of this wall 6, as illustrated in FIGS. 5 and 6. The photograph in FIG. 8 shows a manhole in the structure 9 configured to be disposed opposite the manhole in the wall 6, once the structure 9 has been fastened to the wall 6.

Once inserted into the wall 6, the operator positions the structure 9 in the immediate vicinity of the inner face 7 thereof so that the outer surface Se of the structure 9 nearly fits the contour of the inner face 7, both in the bottom zone 7a thereof and in the lateral zones 7b, 7c thereof (see FIG. 5). In the example in FIG. 5, the inner face 7 incorporates fastening lugs 11 about and between which the ribs 9₁ and the grooves 9₂ of the structure 9 are respectively adapted to be positioned nearly in contact with this inner face 7, over each of the zones 7a, 7b, 7c.

These fastening lugs 11 are part of the means 10 for fastening the structure 9 to the wall 6, and these lugs 11 are for example brackets (i.e. having a substantially double L-shaped cross section), each having (FIG. 6) an outer branch 12 fastened to the inner face 7 that extends perpendicular to the rest of the inner face 7, and an inner branch 13 that extends the outer branch 12 at a right angle and that has fastening orifices 14.

In the example in FIG. 6, the fastening means 10 further comprise, successively towards the inside of the structure 9:
fastening eyelets 15 that are provided in the structure 9 and configured to be disposed opposite and in contact with the fastening holes 14,
clamping profiles 16 that are mounted on the structure 9 and that have clamping openings 17 configured to be disposed opposite and in contact with the fastening eyelets 15, and
clamping bolts (identified by the axis of symmetry 18 thereof) that successively traverse the fastening lugs 11, the structure 9 and the clamping profiles 16 via the fastening holes 14, the fastening eyelets 15 and the clamping openings 17, respectively.

Fastening these means 10 of the structure 9 to the inner face 7 of the wall 6 enables the operator to simply and efficiently carry out the full assembly of the retention device 8 inside the wall 6, and thus complete construction of the tank 5 before the tank is filled with aircraft fuel.

The tank 5 thus built was filled with sustainable aviation fuel (SAF) comprising Jet A1 and, as detailed below, the retention device 8 according to the invention was entirely immersed in this fuel inside the wall 6 and then checked to ensure that it was able to retain the fuel satisfactorily at a fuel height of approximately 2 m, with a perforation in the wall 6 of the tank 5 in the form of a rectangular hole 500 mm long and 100 mm wide.

### Flexible Composite Structure Manufactured According to an Example of the Invention:

A cross-linkable rubber composition was prepared using fluorosilicone rubber (FVMQ), the composition having the formulation detailed in Table 1 below (mass fractions of the ingredients in the composition).

TABLE 1

| Ingredients | Mass fractions |
|---|---|
| FVMQ rubber | 83.9% |
| Carbon nanoparticles | 13.0% |
| Fireproof additive | 0.9% |
| Cross-linking agent (organic peroxide) | 2.2% |

This cross-linkable rubber composition was then thermally cross-linked to obtain the cross-linked rubber composition that, in the initial state (i.e. before ageing) and after ageing in various aeronautical fuels respectively comprising Jet A1, pure HEFA (hydroprocessed esters and fatty acids) and HEFA supplemented by various aromatic compounds, exhibited the mechanical properties set out in Tables 2 and 3 below.

### Tests on the Obtained Cross-Linked Rubber Composition:

Tables 2 and 3 set out the measured average breaking strength, the average elongation at break, and the secant moduli M50, M100, M200 at 50%, 100% and 200% deformation in uniaxial tension according to standard ISO 37:2017. Shore A hardness was also measured according to standard ASTM D2240.

Table 3 sets out the measured swelling of the composition according to standard NF ISO 1817, after ageing for 1000 hours at 70° C. in the fuels Jet A1 (No. 1), pure HEFA (No. 2) and in HEFA fluids supplemented with compounds:
HEFA+8% aromatic compounds: No. 3,
HEFA+15% aromatic compounds: No. 4,
HEFA+8% aromatic compounds+10-12% naphthenes: No. 5,
HEFA+15% naphthenes: No. 6.

TABLE 2

| Initial properties before ageing | Values |
|---|---|
| Average breaking strength | 2.8 MPa |
| Average elongation at break | 305% |
| Secant modulus M50 at 50% deformation | 1.0 MPa |
| Secant modulus M100 at 100% deformation | 1.3 MPa |
| Secant modulus M200 at 200% deformation | 2.0 MPa |
| Shore A hardness after 15 seconds | 53 |

TABLE 3

| | | Ageing for 1000 hours at 70° C. in the | | | | | |
|---|---|---|---|---|---|---|---|
| | Initial | aforementioned fluids No. 1 to No. 6 | | | | | |
| | state | No. 1 | No. 2 | No. 3 | No. 4 | No. 5 | No. 6 |
| Breaking strength | | | | | | | |
| Average in MPa | 2.8 | 1.5 | 1.7 | 1.6 | 1.6 | 1.5 | 1.6 |
| Standard deviation in MPa | 0.1 | 0.1 | 0.05 | 0.04 | 0.08 | 0.3 | 0.09 |
| Variation in % | | −46 | −39 | −43 | −43 | −46 | −43 |
| Elongation at break | | | | | | | |
| Average in % | 305 | 176 | 181 | 190 | 177 | 156 | 167 |
| Standard deviation in % | 12 | 21 | 18 | 8 | 12 | 23 | 13 |
| Variation in % | | −42 | −41 | −38 | −42 | −49 | −45 |
| Moduli (MPa) | | | | | | | |
| M50 | 1.0 | 1.7 | 0.8 | 0.8 | 0.8 | 0.8 | 0.8 |
| M100 | 1.3 | 1.1 | 1.1 | 1.1 | 1.1 | 1.1 | 1.2 |
| M200 | 2.0 | 1.6 | 1.7 | 1.4 | — | — | — |
| Volume swelling after | | 28 | 22 | 25 | 25 | 27 | 25 |
| removal from fluid | | | | | | | |
| Mass swelling after | | 16 | 12 | 13.7 | 14.2 | 14.9 | 13.6 |
| removal from fluid | | | | | | | |
| Volume swelling after | | 0 | −1 | −1 | −1 | −1 | −1 |
| removal from fluid after | | | | | | | |
| drying for 24 hours at | | | | | | | |
| 100° C. | | | | | | | |
| Shore A hardness after | 53 | 34 | 37 | 39 | 38 | 35 | 37 |
| 15 seconds | | | | | | | |
| Shore variation (points) | | −19 | −16 | −14 | −15 | −18 | −16 |

The following was observed following this thermal ageing in these fluids:
a reduction in breaking strength and elongation at break of less than 50%,
a reduction in the moduli at 50%, 100% and 200% of less than 50%, 5-swelling after removal from fluid, according to NF ISO 1817, of less than 30% (by volume) and less than 20% (by mass), and
a reduction in Shore A hardness after 15 seconds of less than-20 points.

Consequently, Table 3 shows that the rubber composition used to form the elastomer body 9A of the flexible composite structure 9 according to the invention exhibited satisfactory resistance to swelling, given that the mechanical properties thereof were not significantly worsened following thermal ageing of the body 9A in aircraft fuels.

### Preparation of Reinforcing Frame 9B and Fireproof Frame 9C:

To obtain a flexible composite structure 9, the reinforcing frame 9B was prepared using a woven aramid ply, as specified below. More specifically, the woven aramid ply was made of continuous threads of PPTA (para-aramid or poly(para-phenylene terephthalamide)) with a linear density of 1680 tex. This aramid ply had, in the woven state (1/1 weave with 8.5-10.5 warp/weft threads):
a width of 155 cm, measured according to ISO 2286-1,
a mass per unit area of 290 g/m², measured according to ISO 9073-1,
a thickness of 0.5 mm, measured according to ISO 5084,
a tensile strength along warp and weft of 1150 and 1250 daN/5 cm respectively, measured according to ISO 13934-1, and
a bursting strength of 18.10⁵ Pa, measured according to ISO 13938-1.

Moreover, the fireproof frame 9C was prepared using a woven silica ply, as specified below. More specifically, the silica ply was made of continuous silica threads (comprising more than 95% SiO₂ fibres) with a diameter of 6 μm. This silica ply had, in the woven impregnated state:
a maximum continuous usage temperature of 800° C.,
a width of 120 cm, measured according to ISO 2286-1,
a mass per unit area of 300 g/m², measured according to ISO 3801,
a thickness of 0.44 mm, measured according to ISO 5084,
a tensile strength along warp and weft of 822 N/25 mm (32.8 KN/m) and 650 N/25 mm (26 kN/m) respectively, measured according to ISO 4606,
an elongation at break along warp and weft of 6% and 7% respectively, measured according to ISO 13934-1, and
a bursting strength of 792 kPa (diameter of test piece 30.5 mm), measured according to ISO 13938-1.

The flexible composite structure 9 incorporating the frames 9B and 9C were shaped by calendering and molding, embedding the two plies thereof (woven aramid ply and woven silica ply) in the elastomer body 9A to obtain the shaped three-dimensional structure 9.

### Puncture Resistance and Sheer Strength of the Structure 9 Thus Obtained:

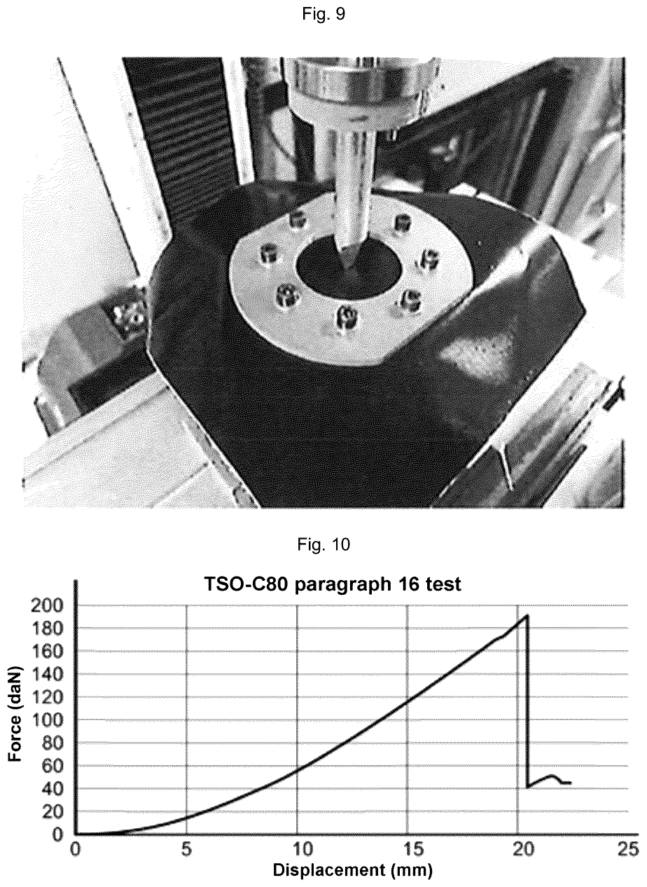

The puncture resistance of the flexible composite structure 9 thus shaped was tested according to the standard TSO-C80, paragraph 16, using the device illustrated in FIG. 9. As shown in the graph in FIG. 10, the results obtained in terms of typical force (daN)=f (displacement mm) demonstrated a puncture resistance of approximately 1900 N (see drop in force measured at 190 daN), which is significantly greater than the minimum required value of 1646 N.

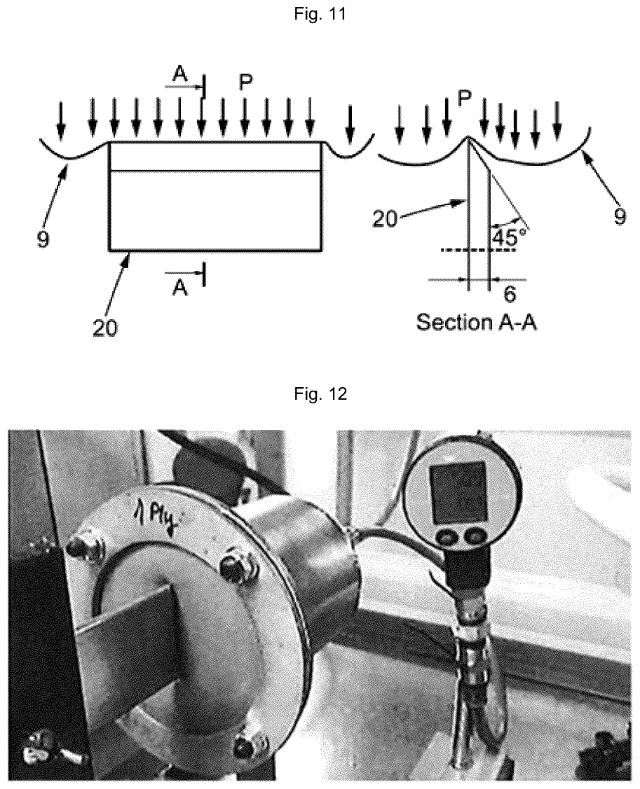

The sheer strength of the flexible composite structure 9 thus shaped was also tested, following the experimental protocol illustrated in FIGS. 11 and 12, i.e. by applying shear stresses to a surface unit (i.e. stresses representative of a pressure) by means of a metal plate 20 that was 6 mm thick, the inclination of which varied by an angle of up to 45° to simulate shearing, and against which the outer surface Se of a sample of the structure 9 mounted movably in translation was pressed (see parallel arrows P in FIG. 11). The woven aramid ply ultimately provided the structure 9 with a shear strength of up to 50,000 Pa (500 mbar), which is much greater than the minimum requirement of 18,000 Pa (180 mbar).

These results demonstrate that the flexible composite structure 9 according to the invention is able to satisfactorily withstand the stresses generated by sharp edges of a hole resulting from a perforation of the external rigid wall 6 of a fuel tank 5. In particular, the aramid ply provides the structure 9 with sufficient resistance to the pressure of the fuel and to tearing as a result of contact between the structure 9 and these sharp edges of the perforated wall 6 of the tank 5.

### Fire Resistance and Fluidtightness of the Structure 9 Following Exposure to Fire:

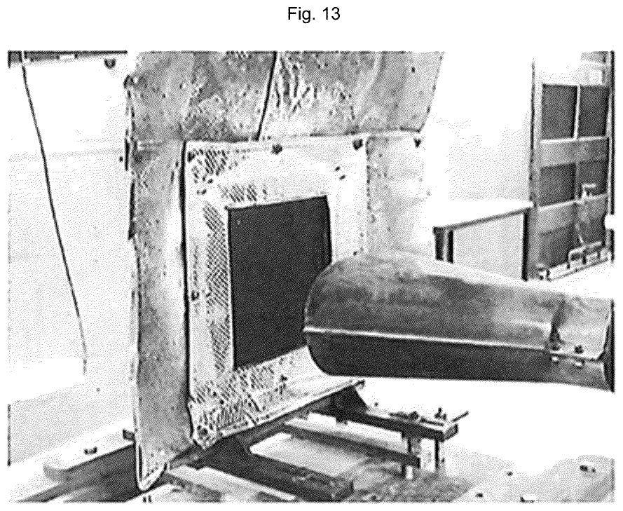

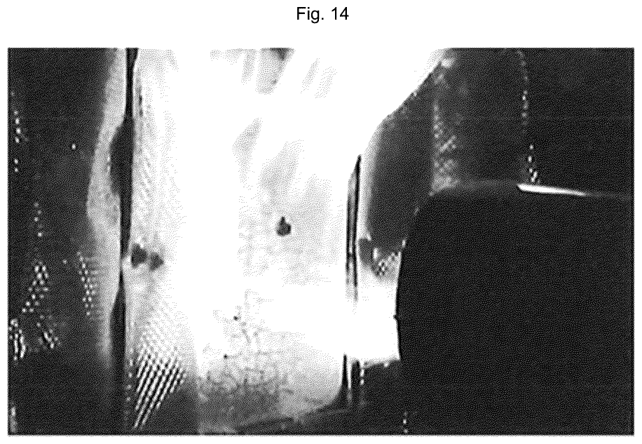

As shown in FIGS. 13 and 14, a fuel burner was used to carry out a fire resistance test on the structure 9 according to standard ISO 2685:1998 or FAA standard AC 20-135, using a Jet A1 fuel burner. A final fire resistance of 5 minutes was obtained using this burner, said fire resistance being notably provided by the silica fireproof ply.

The fluidtightness of the structure 9 was then evaluated as a water leakage rate using a column of water sprayed onto the structure 9 after said structure 9 had been exposed to a kerosene flame of 92 kW/m² for 5 minutes. It was concluded that the structure 9 remained fluidtight against the water thus sprayed, even after exposure to this calibrated kerosene flame.

### Other Measured Properties of the Structure 9 and Conclusion:

It was determined that the structure 9 prepared according to FIGS. 3, 7 and 8 provided lasting flexibility at temperatures of between-55 and 80° C., that the carbon nanoparticles ensured the dissipation of electrostatic charges (measured electrical surface resistance of less than 10 GΩ square), and that this structure 9 was self-extinguishing according to standard FAR 25.853 Appendix F Part 1 in the vertical burn test according to (a1)(ii) and the horizontal burn test according to (a1)(iv), burning for 12 seconds and 15 seconds respectively.

In conclusion, the applicant has established that a flexible composite structure according to the invention notably has very satisfactory properties in terms of flexibility, service life, resistance to aircraft fuels at both high and low temperatures, puncture resistance, fire resistance, fluidtightness and dissipation of electrostatic charges, these properties enabling the structure to remain close to the profile of the outer rigid wall of the fuel tank over time, thereby minimizing the risk of initial spillage of a large quantity of fuel, while retarding and reducing the fuel leak over time, with an estimated service life of the retention device incorporating the flexible composite structure of at least 12 years.

1. A flexible composite structure (9) configured to form, in the deployed state, a retention device (8) for retaining fuel of an aircraft (1), the retention device (8) being mounted inside and away from a wall (6) of a tank (5) of an aircraft (1) containing the fuel, so that the retention device (8) retards or reduces the fuel leak from the tank (5) if the wall (6) is perforated,
the flexible composite structure (9) having an inner surface (Si) intended to be in contact with the fuel and an outer surface (Se), and being configured so that, once shaped and deployed, the outer surface (Se) is mounted in the immediate vicinity of and along the contour of the wall (6) of the tank (5),
the flexible composite structure (9) comprising an elastomer body (9A) made of a rubber composition and a reinforcing frame (9B) embedded in the elastomer body (9A),
wherein the flexible composite structure (9) further comprises a fireproof frame (9C) that is embedded in the elastomer body (9A) away from the reinforcing frame (9B), the rubber composition being based on at least one fluorosilicone rubber.

2. The flexible composite structure (9) according to claim 1, wherein the fireproof frame (9C) is positioned between the reinforcing frame (9B) and the outer surface (Se).

3. The flexible composite structure (9) according to claim 1, wherein the inner surface (Si) and the outer surface (Se) are made of the rubber composition.

4. The flexible composite structure (9) according to claim 1, wherein the reinforcing frame (9B) comprises at least one textile reinforcement ply that is woven or knitted, preferably woven using a continuous thread and satisfying at least one of the following conditions:
a mass per unit area of at least 250 g/m², measured according to ISO 9073-1,
a tensile strength along warp and weft of at least 1100 daN/5 cm and 1200 daN/5 cm respectively, measured according to ISO 13934-1, and
a bursting strength of at least 15.105 Pa, measured according to ISO 13938-1.

5. The flexible composite structure (9) according to claim 4, wherein said at least one reinforcement ply comprises fibres of a (semi) aromatic polyamide, preferably chosen from polyarylamides, poly(meta-xylylene adipamide), polyphthalamides, amorphous semi-aromatic polyamides, meta-aramids, para-aramids, and combinations thereof.

6. The flexible composite structure (9) according claim 1, wherein the fireproof frame (9C) comprises at least one woven or knitted mineral fireproof ply that satisfies at least one of the following conditions, preferably being woven and satisfying at least one of the following conditions in the impregnated state:
a mass per unit area of at least 250 g/m², measured according to ISO 3801,
a tensile strength along warp and weft of at least 800 N/25 mm and at least 600 N/25 mm respectively, measured according to ISO 4606,
an elongation at break along warp and weft of at least 4% and 5% respectively, measured according to ISO 13934-1, and
a bursting strength of at least 750 kPa for a test piece diameter of 30.5 mm, measured according to ISO 13938-1.

7. The flexible composite structure (9) according to claim 6, wherein said at least one fireproof ply comprises fibres of silica and/or a ceramic, preferably a continuous silica thread with a mass fraction of SiO₂ greater than 95% in said at least one ply.

8. The flexible composite structure (9) according to claim 1, wherein the rubber composition comprises:
said at least one fluorosilicone rubber, for example with a mass fraction of 80% to 88%,
electrically conductive fillers comprising for example carbon nanoparticles, preferably with a mass fraction of 10% to 15%,
a flame retardance system, preferably with a mass fraction of 0.5% to 2%, and
a cross-linking system, for example peroxide-based, preferably with a mass fraction of 0.5% to 5%.

9. The flexible composite structure (9) according to claim 1, wherein the rubber composition satisfies, in the cross-linked state, at least one of the following conditions:
an average breaking strength of at least 2.5 MPa, measured in uniaxial tension according to standard ISO 37:2017,
an average elongation at break of at least 300%, measured in uniaxial tension according to standard ISO 37:2017,
secant moduli at 50%, 100% and 200% deformation respectively of at least 0.8 MPa, 1.0 MPa and 1.8 MPa, measured in uniaxial tension according to standard ISO 37:2017, and
a Shore A hardness of between 50 and 60, measured according to standard ASTM D2240.

10. The flexible composite structure (9) according to claim 1, wherein the flexible composite structure (9) satisfies, in the cross-linked state, at least one of the following conditions:
a puncture resistance according to TSO-C80, paragraph 16, that is greater than 1650 N,
a fire resistance according to ISO 2685:1998 or FAA AC 20-135 using a Jet A1 fuel burner of at least 5 minutes,
a fluidtightness measured as a water leakage rate, following application of a kerosene flame of 92 kW/m², for at least 5 minutes,
a self-extinguishing time according to FAR 25.853 Appendix F Part 1 in the vertical burn test according to (a1)(ii) and the horizontal burn test according to (a1)(iv), that is at least 12 seconds and at least 15 seconds burning respectively,
an electrical surface resistance of less than 10 GΩ square, and
following ageing for 1000 hours at 70° C. in Jet A1 fuel, swelling after removal from the fluid, according to standard NF ISO 1817, of less than 30% by volume and less than 20% by mass.

11. A retention device (8) for retaining fuel of an aircraft (1), the retention device (8) being configured to be mounted inside and away from a wall (6) of a tank (5) of an aircraft (1) containing the fuel, so that the retention device (8) immersed in the fuel retards or reduces the fuel leak from the tank (5) if the wall (6) is perforated,
wherein the retention device (8) comprises:
the flexible composite structure (9) according to claim 1 shaped, for example by calendering and molding, then deployed along the contour of an inner face (7) of the wall (6), and
fastening means (10) for fastening the flexible composite structure (9) to the inner face (7) of the wall (6), the fastening means (10) preferably comprising the following, from the wall (6) of the tank (5) towards the inside of the flexible composite structure (9):
fastening lugs (11), for example brackets, that are fastened to an inner face (7) of the wall (6) of the tank (5) and that have fastening holes (14),
fastening eyelets (15) that are provided in the flexible composite structure (9) and configured to be disposed opposite and in contact with the fastening holes (14),
clamping profiles (16) that are mounted on the flexible composite structure (9) and that have clamping openings (17) configured to be disposed opposite and in contact with the fastening eyelets (15), and
male clamping members (18), such as bolts, that successively traverse the fastening lugs (11), the flexible composite structure (9) and the clamping profiles (16) via the fastening holes (14), the fastening eyelets (15) and the clamping openings (17), respectively.

12. The retention device (8) according to claim 11, wherein the flexible composite structure (9), once shaped and deployed:
has a manhole access opening configured to be positioned opposite an access hatch in the wall (6) of the tank (5), and
is capable of being reversibly folded and/or rolled up to fit through the manhole access opening to be subsequently deployed inside the tank (5).

13. A fuel tank (5) configured to be installed in an aircraft (1) comprising a fuselage (2) containing a cabin (2a), the tank (5) comprising:
a metal or composite rigid outer wall (6) delimiting a compartment for the fuel, and
the retention device (8) according to claim 11 or 12,
wherein the retention device (8) is held by said fastening means (10) in the immediate vicinity of the wall (6) with an average gap between the outer surface (Se) of the flexible composite structure (9) and the inner face (7) of the wall (6) of between 1 mm and 10 mm, preferably between 2 mm and 8 mm.

14. The fuel tank (5) according to claim 13, wherein at least one of the sides of the retention device (8) extending across the wall (6) of the tank (5) is open, the retention device (8) being arranged across a bottom zone (7a) and lateral zones (7b, 7c) of the wall (6) and preferably being open across a top zone (7d) of the wall (6), said top zone (7d) being configured to be disposed inside the fuselage (2) of the aircraft (1) and beneath the cabin (2a).

15. An aircraft (1) comprising a fuselage (2), wings (3 and 4) and at least one fuel tank (5) that is housed inside the fuselage (2), preferably at the join between the fuselage (2) and one of the wings (3), wherein said at least one tank (5) is as defined in claim 13 or 14 and has for example a lateral zone (7b, 7c) of said wall (6) that is delimited by the fuselage (2) or is adjacent to the fuselage (2).
